(19) United States
(12) Patent Application Publication
(10) Pub. No.: US 2007/0028459 A1
(43) Pub. Date: Feb. 8, 2007

(54) String trimmer

(76) Inventors: Paul Thomson, Cincinnati, OH (US); Pamela A. Menges, Cincinnati, OH (US)

Correspondence Address: Mark F. Smith, 905 Ohio Pike, Cincinnati, OH, 45245, US

(21) Appl. No.: 11/500,049

(22) Filed: Aug. 7, 2006

Related U.S. Application Data
(60) Provisional application No. 60/706,416, filed on Aug. 8, 2005.

(51) Int. Cl. B25B 23/18; B26B 7/00

(52) U.S. Cl. 30/276; 362/120

(57) ABSTRACT

The present invention is a string trimmer having a cutting line that can be easily seen by the operator during use. In a preferred embodiment of the invention the trimmer comprises a cutting line having a cutting portion and a radial tip wherein the cutting line has a refractive index sufficient for conducting light along the length of the cutting line towards its radial tip.

### BACKGROUND OF THE INVENTION

The advent of string trimmers some years ago proved a great boon to yard, garden, and landscape maintenance. Rather than rigid metal blades, these string trimmers use a flexible line to cut vegetation, and this flexible cutting line allows the cutting of grass and other vegetation even when this vegetation lies directly alongside or against various hard obstacles such as walls, rocks, etc. The flexibility of the cutting line also becomes useful when one is cutting vegetation lying closely beside softer objects, such as trees or other desirable plants.

Because such trimmer line needs to be flexible, it tends to be rather soft or pliable. This lack of hardness means that the string must be spun at very high revolutions per minute (rpm) in order to effectively cut vegetation. These facts, along with the fact that the line is often used in situations in which it flails against hard surfaces (e.g. foundation walls, paving, and the like), cause the line to wear down quickly and often unevenly. This disintegration of the line is frequently sudden and unpredictable, leaving the operator unaware that large parts of the trimmer line have vanished altogether. When in use, the high trimmer rpm and the unpredictability of the trimmer line disintegration combine to make it difficult or impossible for the operator to visualize where the ends or tips of the trimmer line are positioned. Because the operator generally cannot see the ends of the rapidly spinning and degenerating line, it is unfortunately not uncommon for the operator to strike and damage or even destroy desirable plants and other structures.

Thus, it would be desirable to have a trimmer having a cutting line that had features that would allow the operator to be able to continuously visualize the end(s) or tip(s) of the line(s), even when that line was spinning at high rpm or in dim light. Such a trimmer line would help the operator avoid striking the line against desirable or delicate structures and plants. Further, the ability to visualize the line's spinning tip(s) would improve the safety of the trimmer, as the operator would thus be less likely to strike objects that could be flung into the air if hit or shatter that may cause fragments to be projected into the air.

### SUMMARY OF THE INVENTION

The present invention is a string trimmer having a cutting line that can be easily seen by the operator during use. In a preferred embodiment of the invention the trimmer comprises a cutting line having a cutting portion and a radial tip wherein the cutting line has a refractive index sufficient for conducting light along the length of the cutting line towards its radial tip.

In another preferred embodiment of the invention, the trimmer comprises a light source in optical communication with the cutting line for permitting the transmission of light along the length of the cutting line.

In another preferred embodiment of the invention, the cutting line comprises an inner dielectric core surrounded by an outer dielectric cladding having a lower refractive index than the dielectric core that together operate as an optical waveguide for conducting visible, ultraviolet, or infrared light along the length of the cutting line.

In another preferred embodiment of the invention, the cutting line of the present invention is formed from materials having a refractive index sufficient of conducting light along the length of the cutting line towards its radial tip.

In another preferred embodiment of the invention, the cutting line is constructed from a solid monofilament material capable of transmitting light along its length.

In another preferred embodiment of the invention, the trimmer further comprises a light source for generating visible, infrared or ultraviolet light.

In another preferred embodiment of the invention, the light source is a strobe light.

In another preferred embodiment of the invention, the trimmer further comprises an electric battery for supplying electric power to the light source.

In another preferred embodiment of the invention, the trimmer further comprises a dynamo-type generator for supplying electric power to the light source.

In another preferred embodiment of the invention, the electric power is supplied directly from the electric motor of the trimmer.

In another preferred embodiment of the invention, the cutting line includes numerous branches positioned along the length of the cutting line for creating multiple points of visible light along the entire length of the cutting line.

In another preferred embodiment of the invention, each of the branches has a different emitted visible color, thus enabling the operator to observe the erosion of the cutting line as it is in use.

In another preferred embodiment of the invention, at least some of the branches are configured as a symbol or as different symbols indicating the length of the cutting line that is left to use for cutting.

In another preferred embodiment of the invention, the cutting line is formed having a series of light-reflecting spots or stripes along its length.

In another preferred embodiment of the invention, the entire length of the cutting line has a reflective outer surface.

In another preferred embodiment, the spots or stripes or the entire length of the cutting line are made of phosphorescent materials which can continue to glow for a period of time after being exposed to a light source.

In another preferred embodiment, the trimmer further comprises a sensing device for detecting light at the radial tip of the cutting line and for alert the operator when the cutting line is worn down to a given level.

In another preferred embodiment of the invention, the cutting line contains an abrasive grit, powder, or other tough or crystalline material with abrasive properties for facilitating the cutting line's ability to cut through tough materials.

Other aspects, advantages and embodiments of the invention will be apparent from the following description and the appended claims.

### BRIEF DESCRIPTION OF THE DRAWINGS

FIG. 1 is a perspective view of a sting trimmer of the subject invention showing the rotor head assembly;

FIG. 2 is a side elevation cross-sectional view showing a portion of a preferred embodiment of the cutting line of the subject invention having an inner dielectric core surrounded by an outer cladding that cooperate together as an optical waveguide for conducting light along the cutting portion of the cutting line;

FIG. 3 is a schematic representation illustrating a light-emitting mechanism in optical communication with the axial tip of the cutting line;

FIG. 4 is another preferred embodiment of the invention whereby the cutting line includes a plurality of branches positioned along the cutting line to create multiple points of light;

FIG. 5 is a side elevation cross-sectional view of another embodiment of the invention whereby the cutting line of the subject invention having more than one dielectric core fiber surrounded by an outer cladding that cooperate together as an optical waveguide for conducting light along the cutting portion of the cutting line;

FIG. 6 is a side elevation cross-sectional view of another embodiment of the invention whereby the cutting line includes a series of light-reflecting marks;

FIG. 7 is a schematic representation showing a sensing device having the ability to detect light that is directed towards the cutting line and includes an alarm unit for emitting a visible or auditory alert when the cutting line is worn down to a given level or length;

FIG. 8 is another preferred embodiment of the invention showing the cutting line having an abrasive material for facilitating the cutting line's ability to cut through materials; and

FIG. 9 is another preferred embodiment of the invention showing the rotor hub assembly having a dynamo-type generator mounted along the rotor for creating electric energy for powering a light source;

These and other features, aspects, and advantages of the present invention will become better understood with regard to the following description, appended claims, and accompanying drawings where:

### DETAILED DESCRIPTION OF THE INVENTION

The present invention relates to trimming and more particularly to a string trimmer having a new and novel cutting line. As required, detailed embodiments of the present invention are disclosed herein, however, it is to be understood that the disclosed embodiments are merely exemplary of the invention which may be embodied in various forms, therefore, specific structural and functional details disclosed herein are not to be interpreted as limiting, but merely as a basis for the claims and as a representative basis for teaching one skilled in the art to variously employ the present invention in virtually any appropriately detailed structure.

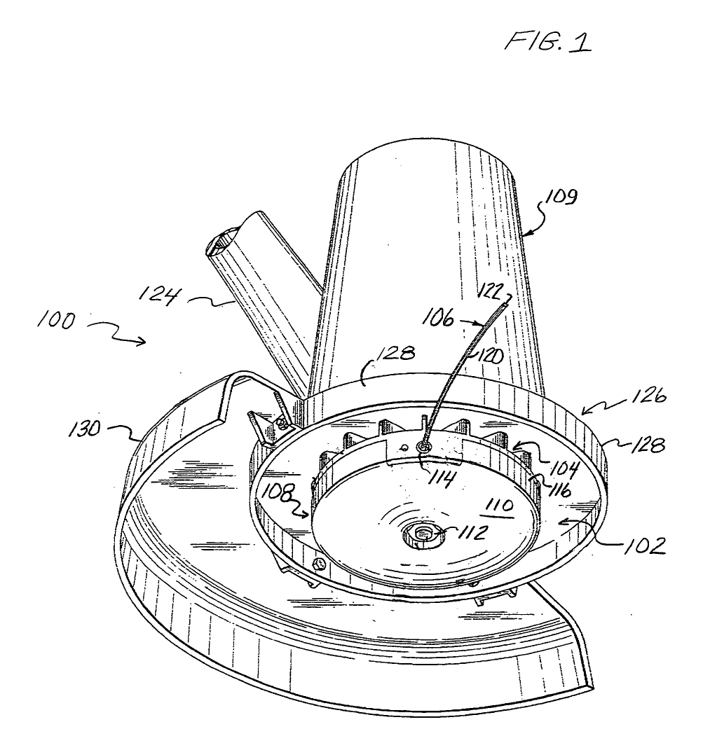

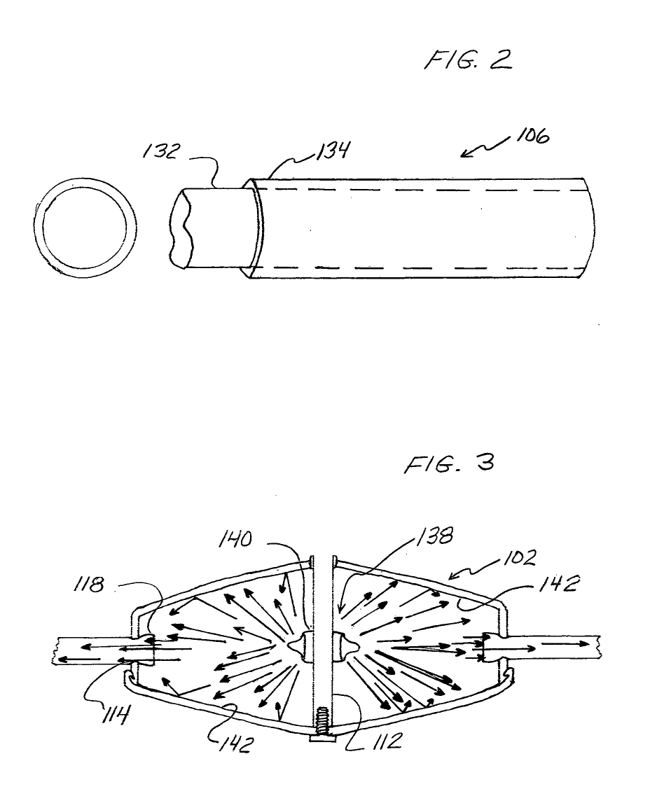

Referring to FIG. 1, a motor driven flexible-line law trimmer 100 of the present invention is shown having a rotor head assembly 102 is shown comprising a rotor 104 and a flexible cutting line 106 removably attached thereto by any conventional means and adapted for use with the lawn trimmer 100. The rotor head assembly 102 comprises a disc-shaped body 108 having a central portion 110 thereof connected with the drive shaft 112 of the trimmer 100 for bodily rotating the rotor 104 and the rotor head assembly 102. At least one aperture 114 is provided and positioned radially through the peripheral portion 116 of the body 108. The cutting line 106 is threaded through the aperture 114 and being of such length that it extends from its axial end 118 (FIG. 3) outwardly of the aperture 114 for a desired length, providing a cutting portion 120 having an radial or outer tip or end 122 for cutting vegetation in response to rotation.

The lawn trimmer 100 includes a motor (not shown) which may be an electric or a gasoline engine in or mounted on a housing or support (not shown) within a housing 109 through which the drive shaft 112 protrudes axially therefrom. An elongate handle 124 is connected with the housing 109, and extends upwardly therefrom to facilitate grasping and manipulation by the user. A base portion 126 of the housing 109, wherein the rotor head assembly 102 is mounted, includes a flange portion 128 under which the cutting portion 120 of the cutting line 106 extends outwardly to engage and cut the vegetation. A shroud or cover member 130 may be attached to the flange portion 128 and extends radially outwardly and downwardly therefrom to form a guard for the protection and safety of the user.

Referring to FIGS. 1 and 2, in a preferred embodiment of the invention, the cutting line 106 comprises an inner dielectric core 132 surrounded by an outer dielectric cladding 134 having a lower refractive index that together operate as an optical waveguide for conducting visible or infrared light along its length of the cutting portion 120 of the cutting line 106. The axial end or tip 118 (FIG. 3) of the cutting line 106 is highly polished and is conventionally secured to the rotor head assembly 102 and adapted to allow light to enter the polished axial end 118 and travel within the cutting line 104 along the cutting portion 120 (FIG. 1) towards the radial tip 122. Preferably, the core 132 is formed from a dielectric transparent plastic capable of transmitting light, such as a step-index multimode fiber formed from polymethyl methacrylate (commonly known as acrylic) and the cladding 134 is formed from a dielectric material, such as a fluorinated polymer. It should be understood, however, that the cutting line 106 of the present invention may also be formed from other materials having a refractive index (ratio of the speed of light in the material to its speed in free space) sufficient of conducting light along the cutting line 106 towards its radial tip 122 (FIG. 1). For example, the cutting line may be formed from various translucent or semi translucent materials forming the core and having cladding formed from materials such as polypropylene, TEFLON, nylon and other like materials for improving the refractive quality of the core.

In another preferred embodiment of the invention, the cutting line 106 is constructed from a solid monofilament material capable of transmitting light along a portion of its length. Such materials include, but are not limited to nylon or polypropylene.

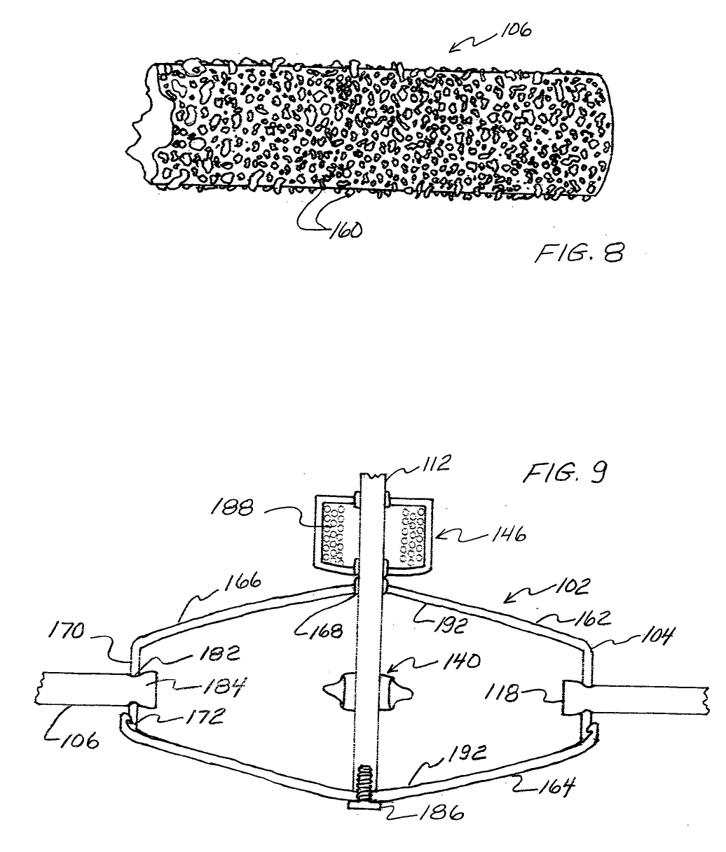

In a preferred embodiment of the invention, as illustrated in FIGS. 1 and 3, the trimmer 100 further comprises a light-emitting mechanism or device 138 located within the rotor head assembly 102. The cutting line 106 is stored and secured within the rotor head assembly 102 through one or more of the currently available methods known in the trimmer industry, including, but not limited to clasps, clamps, threading assemblies, etc. The light-emitting device 138 includes a light source 140 provided within a reflective chamber 142 of the rotor head assembly 102 and comprises any source that has the ability to generate visible light, such as a conventional LED. In one preferred embodiment, the light source 140 can include a light bulb, alight-emitting diode, or other such means, preferably powered by an electric battery. In another preferred embodiment, the electrical energy to power the light source 140 is derived from a dynamo-type generator 146, as shown in FIG. 9, which may be conventionally mounted to the drive shaft 112 and spun via the action of the trimmer motor, not shown. In one preferred embodiment, the light source 140 is an integral part of the trimmer 100 as purchased by the consumer; in another preferred embodiment, the light source 140 is a separate component that attaches to the original non-light emitting rotor assembly 102. In yet another preferred embodiment, the light source 140 can be made so as to attach to the original non-light emitting rotor assembly 102. When in use, any of these light sources 140 described would be in optical communication with the polished axial end 118 of the cutting line 106 for transmitting visible light along the cutting portion 120 of the cutting line 106 with the ultimate effect of illuminating at least a portion of the cutting line 106 and/or preferably creating a point of visible light at the radial tip 122 (FIG. 1) of the cutting line 106. When revolving at high rpm with the rest of the cutting line 106, this point of light at the radial tip 122 would appear to the operator as a circle of light (due to the optical effect known as “persistence of vision”). This circle would thus allow the operator to know where the radial tip 122 of the cutting line 106 was located, hence helping to prevent the operator from striking the radial tip 122 against various objects, such as desirable plants.

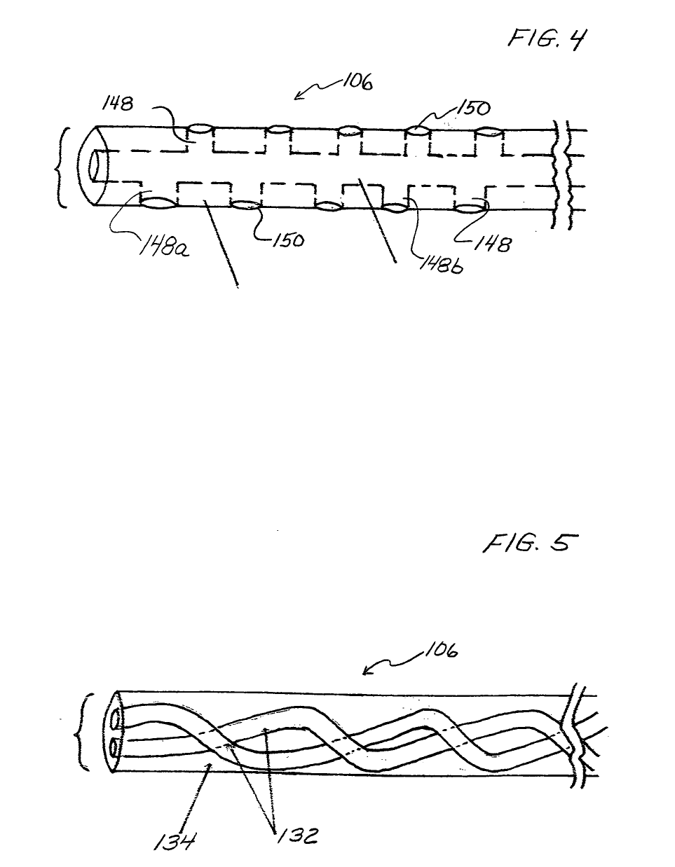

FIGS. 1 and 4 depicts another preferred embodiment of the invention. Here, the cutting line 106 includes numerous branches 148 positioned along the length of the cutting line 106. These branches 148 create multiple points 150 of visible light along the cutting portion 120 of the cutting line 106, allowing the operator to visualize the entirety of the cutting portion 120 of the cutting line 106 and arc. In a preferred embodiment, each of the branches 148 would have a different emitted visible color, thus enabling the operator to observe the erosion of the cutting line 106 as it is in use (for example, the original radial tip 122 at full length might be green, the branch 148a at ¾ Line length might be blue, the branch 148b at ½ Line length might be red, etc.). These branches 148 could be regularly spaced along the cutting line 106, or they could occur at random intervals. In another preferred embodiment of the invention, at least some of the branches 148 can be configured as a symbol or different symbols indicating the length of the cutting line 106 left to use for cutting.

FIG. 5 illustrates another preferred embodiment of the invention. Here, the cutting line 106 comprises more than one inner core 132 that twist around each other within the cladding 134 of the cutting line 106. It should now be apparent to one skilled in the art that any number of configurations of cutting lines having various core geometries are possible.

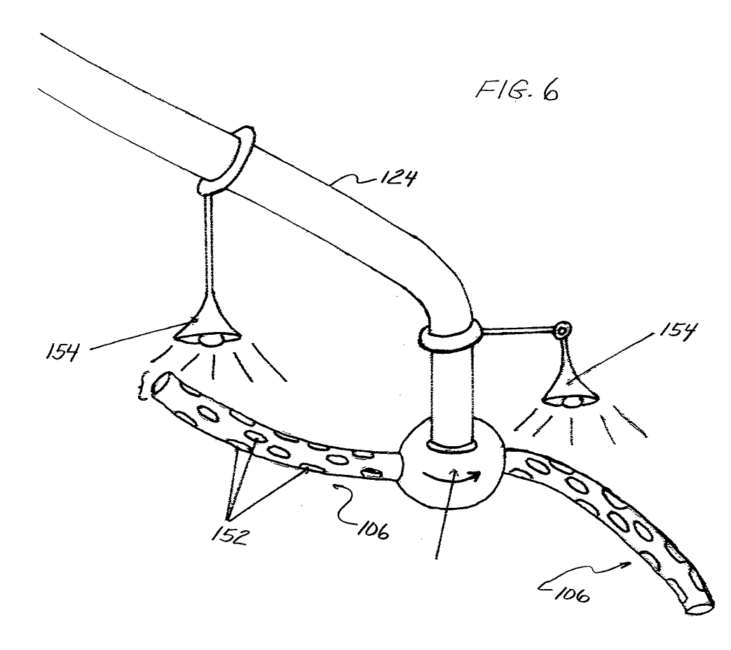

FIGS. 1 and 6 shows another preferred embodiment of the invention. Here, cutting line 106 is formed having a series of light-reflecting marks 152, such as spots or stripes along its length. A light-emitting source 154 is attached to the handle 124 or other part of the trimmer 100. The light source 154 shines its light onto the plane of the cutting line 106, causing the marks 152 to reflect light back up towards the operator, thus allowing the operator to once again visualize the expanse of the cutting line 106. In another preferred embodiment of the invention, the entire length of the cutting line 106 can be reflective. In another preferred embodiment of the invention the light source 154 could be attached at the operator's belt, or may be a naturally-occurring light source, such as the sun. In another preferred embodiment, the marks 152 or the entire outer surface of the cutting line 106 are made of fluorescent materials, and the light source 154 is an ultraviolet (“blacklight”) source. In another preferred embodiment, the marks 152 or the entire length of the cutting line 106 are made of phosphorescent materials which can continue to glow for a period of time after being exposed to a light source.

In another preferred embodiment of the invention, the light source 154 is a strobe light. It should now be apparent to one skilled in the art that use of a strobe light would allow the cutting line 106 to be visualized by the operator regardless of the cutting line's 106 exact constitution (fiber optic, reflective, or ordinary commercially available material.

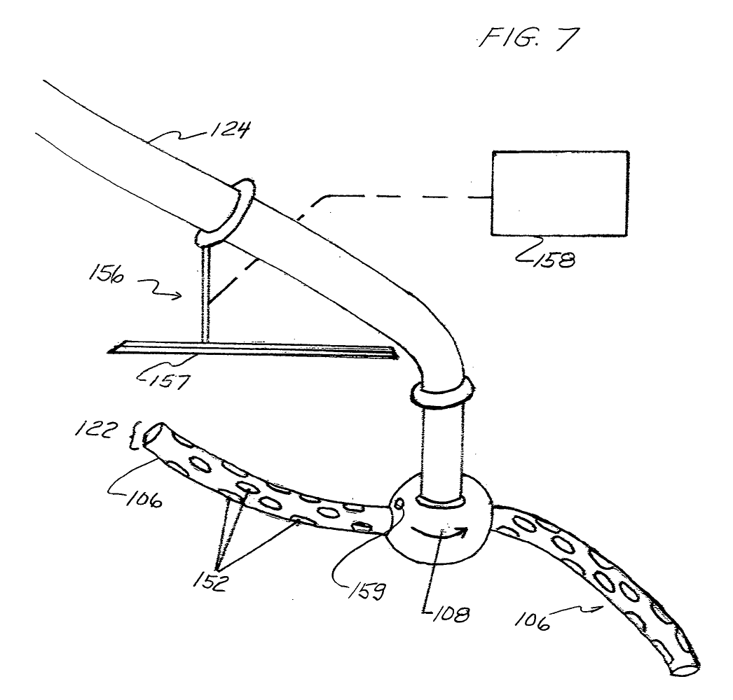

In another preferred embodiment, as shown in FIG. 7, a conventional sensing device 156 having a detector 157 for detecting light is directed towards the cutting line 106. As illustrated here the detector 157 could be a photo cell or an “electric-eye” type detector attached to the handle 124 of the trimmer 100. In this preferred embodiment, the detector 157 detects light emitted from the radial tip 122 as well as light emitted from a light source 154 (FIG. 6) attached to the body 108 of the rotor assembly 102. This light source 154 could be a conventional light bulb, light emitting diode, or simply a perforation 159 of the hub 108 allowing the light generated by the light source 140 (FIG. 3) to exit the upper surface of the hub 108. The sensing device 156 includes programmable or preprogrammed circuitry or a microprocessor which than activates an alarm 158 that is triggered to emit a visible or auditory alert when the cutting line 106 is worn down to a given level or length, thus informing the operator to replace the cutting line 106. In another preferred embodiment, alarm unit 158 may be hard wired as an integral part of the trimmer 100 or it may be attached to the outside of the trimmer 100, or it may be remotely located from the trimmer 100. In another preferred embodiment, alarm unit 158 comprises a beeper-like device worn by the operator. In another preferred embodiment, alarm unit 158 comprises an ear plug providing an audible signal to the operator. In another preferred embodiment, alarm unit 158 is contained within or attached to glasses or goggles, such as safety glasses, worn by the operator. In this embodiment the operator would receive a visual signal from alarm unit 158. In another preferred embodiment, the detector 157 is an infrared detector 157 that cooperates with the light source 140 (FIG. 3) that generates an infrared light which is transmitted along the cutting portion 120 of the cutting line 106 towards the radial tip 122. In this way, the precise location of the radial tip 122 can be easily monitored.

In another preferred embodiment, the detector 157 of the preceding paragraph is a visible, infrared, or ultraviolet light sensor or laser or sonic distance-detecting component that acts as a proximity detector between the radial tip 122 of the cutting line 106 and any nearby object.

In another preferred embodiment of the invention, as shown in FIG. 8, the cutting line 106 contains an abrasive material 160 such as an abrasive grit, powder, or other tough or crystalline material with abrasive properties such as sand, silica, glass powders, carborandum, and the like for facilitating the cutting line's ability to cut through tough materials. The abrasive material 160 could be contained throughout the cutting line 106 or it can be adherent only to the outer surface of the cutting line 106.

Referring to FIG. 9, another preferred embodiment of the invention is shown whereby the rotor head assembly 102 is shown comprising an upper housing 162 and a lower housing 164. The upper housing 162 comprises an upper surface 166 having a central opening 168 and an outer peripheral wall 170 having a hooked edge 172. The lower housing 164 comprises a lower surface 174 having a central opening 176 and an outer periphery wall 178 having a hooked edge 180 that cooperates with the hooked edge 172 of the upper housing 162 for attaching the upper housing 162 and the lower housing 164 together. As shown, the outer peripheral wall 170 of the upper housing 162 includes at least one aperture 182 therein for supporting a cutting line 106. It should be understood that the cutting line 106 can be secured to the rotor head assembly by various conventional means including the use of a stem 184 as shown. As shown, the shaft 112 is positioned through the central opening 168 in the upper housing 162 and secured to the rotor housing by a screw or such other means 186. In a preferred embodiment of the invention, a coil 188 is secured around the shaft 112 and attached to the trimmer housing 109. In a preferred embodiment of the invention, the shaft 112 is formed from a feromagnetic material such when rotated within a coil 188 it conventionally produces electric power which is transferred to the light source 140. Preferably, the upper housing 162 and the lower housing 164 is further provided with a reflective inner surface 192 for increasing the amount of light from the light source 140 being directed to the polished axial end 118 of the cutting line 106 (See FIG. 3).

It should be apparent to one skilled in the art that the string trimmer disclosed hereinabove can include a variety of different configurations that utilize individual segments of cutting line or utilize spooled cutting lines.

Although the foregoing invention has been described in some detail for purposes of clarity of understanding, it will be apparent that certain changes and modifications may be practiced within the scope of the appended claims. Furthermore, it should be noted that there are alternative ways of implementing both the article and method of the present invention. Accordingly, the present embodiments and examples are to be considered as illustrative and not restrictive, and the invention is not to be limited to the details given herein, but may be modified within the scope and equivalents of the appended claims.

We claim:

1. A string trimmer comprising:
a rotor head assembly having a rotor;
a flexible cutting line removably attached to said rotor and having a cutting portion and a radial tip;
wherein said cutting line having a refractive index sufficient of conducting light along said cutting portion of said cutting line towards said radial tip.

2. The trimmer of claim 1 further comprising a light source for transmitting light along at least a portion of said cutting line.

3. The trimmer of claim 1 wherein said cutting line comprises an inner dielectric core surrounded by an outer dielectric cladding having a lower refractive index that together operate as an optical waveguide for conducting visible or infrared light along a portion of said cutting line.

4. The trimmer of claim 1 wherein said cutting line is formed from materials having a refractive index sufficient of conducting light along said cutting portion of said cutting line towards said radial tip.

5. The trimmer of claim 1 wherein said cutting line is constructed from a solid monofilament material capable of transmitting light along its length.

6. The trimmer of claim 1 further comprises a light source for generating visible light.

7. The trimmer of claim 1 wherein said light source is a strobe light.

8. The trimmer of claim 1 further comprising an electric battery for supplying power to said light source.

9. The trimmer of claim 1 further comprising a dynamo-type generator for supplying power to said light source.

10. The trimmer of claim 1 wherein said cutting line comprises branches positioned along the length of said cutting line for creating multiple points of visible light along the entire length or said cutting line.

11. The trimmer of claim 10 wherein each of said branches have a different emitted visible color.

12. The trimmer of claim 10 wherein some of said branches are configured as different symbols indicating the length of said cutting line left to use for cutting.

13. The trimmer of claim 1 wherein said cutting line is formed having a series of light-reflecting marks along the length of said cutting line.

14. The trimmer of claim 1 wherein the entire length of said cutting line is reflective.

15. The trimmer of claim 1 wherein said cutting line comprises marks along the entire length of said cutting line formed from phosphorescent materials.

16. The trimmer of claim 1 further comprising a sensing device for detecting light at said radial tip of said cutting line and for alerting the operator when said cutting line is worn down to a given level.

17. The trimmer of claim 1 wherein said cutting line comprises an abrasive material for facilitating said cutting line's ability to cut through tough materials.

18. A string trimmer having a rotating shaft, the trimmer comprising:
a rotor head assembly having a rotor rotatably driven by the shaft;
at least one flexible cutting line connected to said rotor, said cutting line having a cutting portion, an axial end, and a radial tip;
wherein each said flexible line is effective for transmitting light along said cutting portion towards said radial tip.

19. A string trimmer having a rotating shaft, the trimmer comprising:
a rotor head assembly having a rotor rotatably driven by the shaft;
at least one flexible cutting line connected to said rotor, said cutting line having a cutting portion, an axial end, and a radial tip;
a light source effective for directing light towards said axial end of said cutting line;
wherein each said flexible line is effective for transmitting said light from said axial end along said cutting portion towards said radial tip.
